(19) United States
(12) Patent Application Publication
(10) Pub. No.: US 2004/0227303 A1
(43) Pub. Date: Nov. 18, 2004

(54) Cassette seal

(76) Inventors: Eberhard Bock, Morlenbach (DE); Thomas Klenk, Eppelheim (DE); Manfred Pfadt, Weinheim (DE); Rolf Vogt, Oftersheim (DE)

Correspondence Address: HARNESS, DICKEY & PIERCE, P.L.C., P.O. BOX 828, BLOOMFIELD HILLS, MI, 48303, US

(21) Appl. No.: 10/817,444

(22) Filed: Apr. 2, 2004

(30) Foreign Application Priority Data
Apr. 3, 2003 (DE) 10315370.5-12

(51) Int. Cl. F16J 15/44

(52) U.S. Cl. 277/549

(57) ABSTRACT

A cassette seal, particularly for machines exposed to a high degree of external dust or dirt particles, which between an outer ring and an inner ring, is provided with at least one dust barrier that can be exposed to dust. The at least one dust barrier consists of a nonwoven material impregnated with a polymer dispersion.

### CROSS-REFERENCE TO RELATED APPLICATIONS

This application claims the benefit of German Patent Application 103 15 370.5, filed Apr. 3, 2003, The disclosure of the above application is incorporated herein by reference.

### FIELD OF THE INVENTION

The invention relates to a cassette seal, particularly for machines that are exposed to external dust and dirt and provided with at least one dust barrier that is capable of being exposed to dust, located between the sealing ring and a ball-bearing race.

### BACKGROUND OF THE INVENTION

Cassette seals are preferably used for sealing between the axle of a motor vehicle and the wheel hub. The inner ring of such a seal is firmly connected with the axle, whereas the outer ring rotates with the wheel hub. During their operation, the seals are exposed to an excessive amount of penetrating dirt and dust particles. Moreover, during their installation, which is mostly done by compression, such seals are subjected to a considerable amount of mechanical stress. To keep out the dust and dirt, the seals are often provided with several dust barriers that can be disposed on the inner or outer ring.

EP 0 337 893 A1 discloses a cassette seal in which the outer ring has a sealing lip that rests on the sliding surface of the inner ring and seals off the internal lubricant space from the outside. On the inner ring, as well as on the outer ring, two dust lips are provided that prevent the penetration of dust and dirt into the seal.

EP 0 431 263 B1 describes another seal. The inner and outer ring of this seal are also provided with dust barriers, but in the form of dust lips. This seal has an advantage in that it is designed so that during installation the cassette can absorb high axial forces, but after the cassette has been installed, the axially acting sealing forces of the barrier are very high. This results in undesirably high frictional forces at the seal surfaces.

### SUMMARY OF THE INVENTION

The object of the invention is to provide an improved cassette seal such that frictional forces at the dust barriers and axial stationary seal surfaces are clearly reduced without impairing the dirt- and dust-repelling action of the dust barriers. Moreover, the design of the cassette seal is simple and its fabrication cost low.

The above objective can be reached by providing a cassette seal wherein at least one of the dust barriers is formed of a polymer dispersion-impregnated nonwoven material. A polymer-nonwoven material is a nonwoven material impregnated with an aqueous dispersion. Such a nonwoven material has unusually good sliding properties, particularly on metal surfaces, and also exhibits high wear resistance. Suitable polymer dispersions are aqueous dispersions of PTFE, FEP, PFA, or latex. Preferably, PTFE-nonwoven materials are used because these materials show unusually good properties.

In its simplest embodiment, the PTFE-nonwoven material can be disposed on at least one surface of an outer ring or inner ring that face each other. In this case, it is advantageous for the PTFE-nonwoven material be firmly connected with the outer or inner ring. In another case, the PTFE-nonwoven material rests in a sealing manner on a rotating surface and/or a radial flange of the inner ring. In that case, the PTFE-nonwoven material functions as a supporting disk between the inner ring and the outer ring of the cassette. The PTFE-nonwoven material can also be provided with a sealing lip that rests on the rotating surface of the inner ring.

In another embodiment, the PTFE-nonwoven material is fastened to the radial flange of the inner ring and has a sealing lip that extends outward radially and rests on the outer ring. In this case, on the axially directed outward surface of the inner ring flange, there can be provided another PTFE-nonwoven material with a sealing lip that extends outward radially and rests on the outer ring. In this manner, the two nonwoven materials can form a grease chamber.

In a number of applications, it is not necessary that the PTFE-nonwoven material be firmly connected with a sealing ring. That is, a good sealing action can be achieved when the PTFE-nonwoven material is merely inserted between the outer and inner ring. In this case, to press the PTFE-nonwoven material against the sealing surfaces reliably, the inner ring is preferably provided with an axially oriented leg that extends into one of a plurality of annular spaces that are formed by the stiffening body of the outer ring. Further, when the PTFE-nonwoven material is inserted between the outer and the inner ring, it is wedged and held firmly between the leg and the outer ring.

Yet another embodiment is where the PTFE-nonwoven material is wedged between the surfaces of the outer ring and inner ring that axially face each other. In this case, the PTFE-nonwoven material can rest with its inner edge on the rotating surface and/or with its outer edge on the leg of the inner ring.

In all of the afore-said embodiments, the inner ring is advantageously provided with at least one sealing lip that rests on the stiffening body of the outer ring and/or housing wall.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a longitudinal cross-section of a cassette seal according to a principle of the present invention with a PTFE-nonwoven material attached to an outer ring and which is provided with an axial sealing surface;

FIG. 2 shows a longitudinal cross-section of a cassette seal according to a principle of the present invention with a PTFE-nonwoven material on an outer ring and which has an axial sealing surface and a radial sealing lip;

FIG. 3 shows a cassette seal according to a principle of the present invention in which an inner ring has two radially extending PTFE-nonwoven materials which form a lubricant chamber;

FIG. 4 shows a cassette seal according to a principle of the present invention with an inserted PTFE-nonwoven material; and

FIG. 5 shows an embodiment of a cassette seal according to a principle of the present invention with an inserted PTFE-nonwoven material.

### DETAILED DESCRIPTION OF THE PREFERRED EMBODIMENTS

The following description of the preferred embodiments is merely exemplary in nature and is in no way intended to limit the invention, its application, or uses.

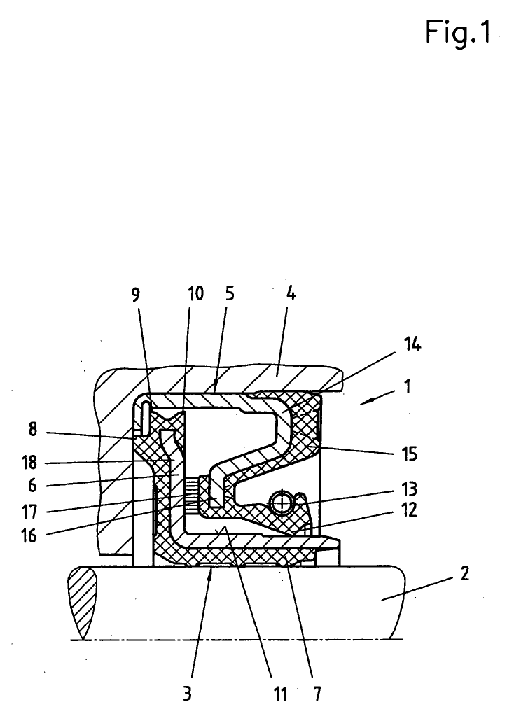

FIG. 1 shows, in longitudinal cross-section, a cassette seal 1 which is designed for high exposure to dirt. Cassette seal 1 in essence consists of an inner ring 3 that is firmly connected with an axle 2, and an outer ring 5 located in a housing 4. The inner ring 3 consists of a bent metallic supporting ring 6 with an elastomer 7 applied thereon. The elastomer 7 is provided with dust lips 8, 9 and 10 that prevent entry of dust particles into the interior of the cassette seal. On a rotating surface 11 of the inner ring 3 rests a sealing lip 12 of the outer ring 5. The sealing lip 12 is additionally pressed against the rotating surface 11 by a coil spring 13. The outer ring 5 also has a stiffening ring 14 that holds sealing lip 12 and also is held over the elastomer covering 15 in the housing 4. To an axially inward bent edge 16 of the stiffening ring 14 is applied a PTFE-nonwoven material 17 that rests in an axially elastic manner on a radial flange 18 of the inner ring 3. The PTFE-nonwoven material 17 is connected to the elastomer covering 15 of the outer ring 5. This arrangement of a PTFE-nonwoven material 17 in the cassette seal 1 provides very good sealing against dust because the PTFE-nonwoven material 17 can rest with a relatively large surface area on the flange 18 without generating any excessive frictional forces. Moreover, the PTFE-nonwoven 17 is highly elastic so that, during the installation of the cassette into the housing 4 which is carried out using high forces, the PTFE-nonwoven material 17 can be compressed in an axial direction, after which, following the axial receding of the outer ring 5 relative to the inner ring 3, the previously compressed PTFE-nonwoven material 17 can again expand and retain its sealing function.

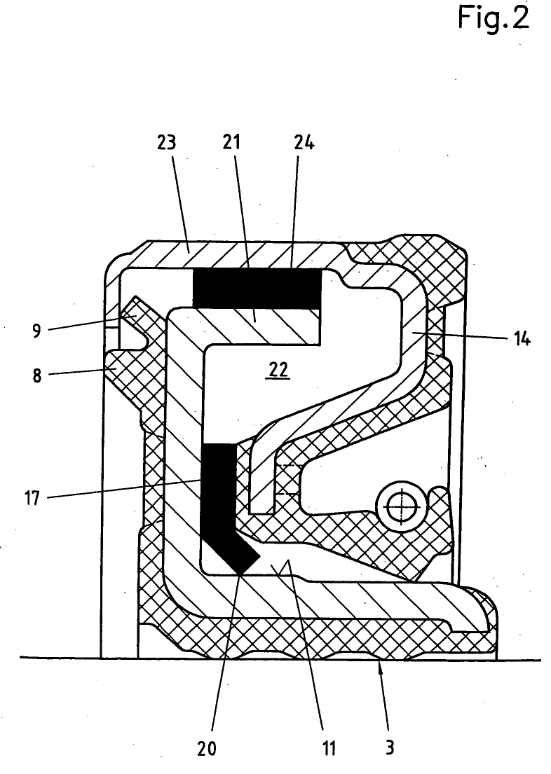

FIG. 2 shows an embodiment of a cassette comparable to that of FIG. 1, with the difference being that the inserted PTFE-nonwoven material 17 is additionally provided with a sealing lip 20 that rests on a rotating surface 11 of the inner ring 3. The inner ring 3 is provided with an axially oriented leg 21 that extends into a ring space 22 formed by a stiffening body 14 of the outer ring 5. Between the leg 21 and an outer ring wall 23 is inserted a ring 24 made of a PTFE nonwoven material. The ring 24 is glued to the leg 21 to form an additional barrier against external dirt.

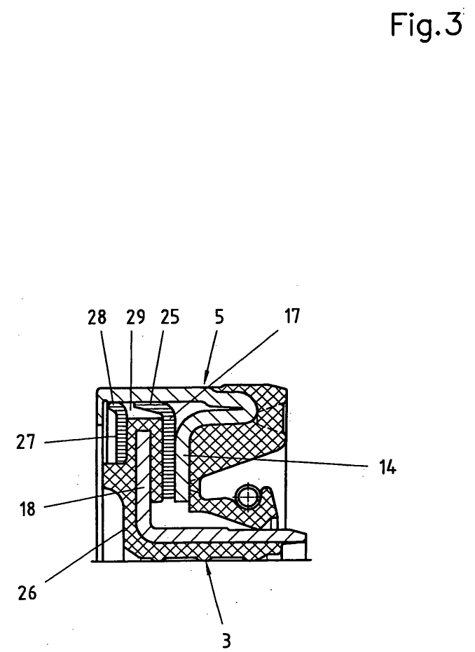

FIG. 3 shows an embodiment of a cassette seal wherein the PTFE-nonwoven material 17 is fastened to a radial flange 18 of the inner ring 3. The PTFE-nonwoven material 17 is provided with a sealing lip 25 that extends outward radially and rests on the outer ring 5. Moreover, another PTFE-nonwoven material 27 is applied to an axially outward oriented surface 26 of the inner ring flange 18. This PTFE-nonwoven material also rests with a sealing lip 28 on the outer ring 5. Here, the outer ring 5 is formed by stiffening body 14 that provides a good sliding surface for PTFE-nonwoven materials 17 and 27. Hence, outward sealing ends are formed at sealing lips 25 and 28 and, additionally, a relatively large sealing surface is formed by the axially acting sealing surface of the PTFE-nonwoven material 17 at the stiffening body 14. When the seal rotates, the PTFE-nonwoven material 17 runs on the metallic stiffening body 14 so that only minimal frictional forces are generated.

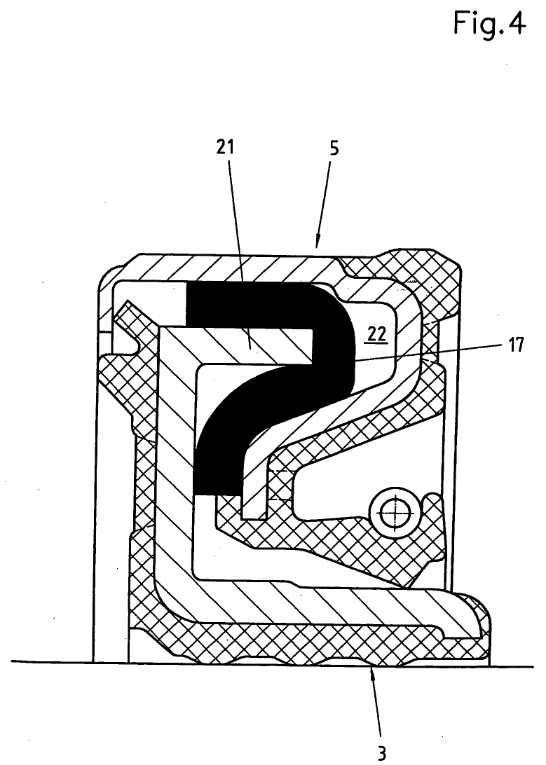

FIG. 4 shows an embodiment comparable to that of FIG. 2. The PTFE-nonwoven material 17 used in this case, however, is not connected with the inner ring 3 or the outer ring 5, but during the installation of the cassette, is inserted between the inner ring 3 and the outer ring 5. The PTFE-nonwoven material 17 can initially have the shape of a disk. Only when the inner ring 3 and the outer ring 5 are pressed together does the nonwoven material assume the shape shown in the drawing. That is, when the PTFE-nonwoven material 17 is pressed by the leg 21 into the annular space 22 of the outer ring 5. In this manner, the PTFE-nonwoven material 17 is wedged between the leg 21 and the outer ring 5. The sealing surfaces thus formed between the PTFE-nonwoven material 17, the inner ring 3, and the outer ring 5 provide very good sealing against dust, while at the same time the friction and heat generation are minimal.

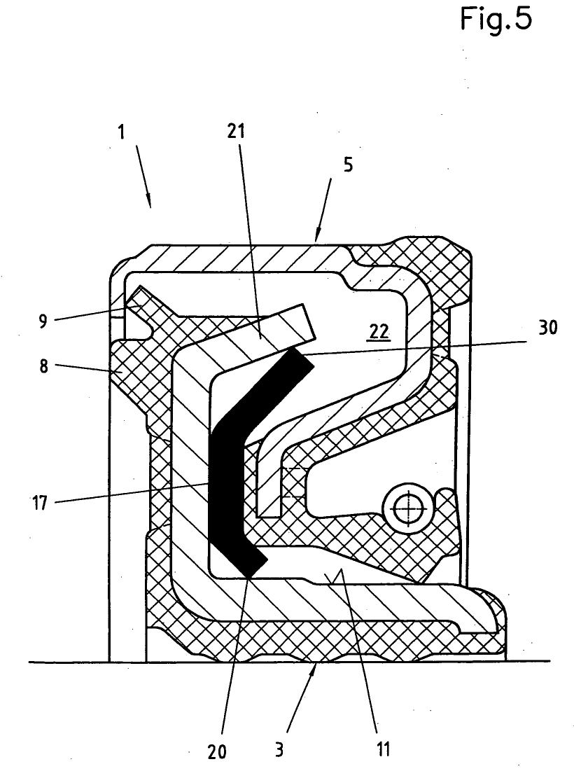

FIG. 5 shows an embodiment of cassette 1 wherein the PTFE-nonwoven material 17 is wedged between the surfaces of the outer ring 5 and the inner ring 3 that axially face each other and is connected to the outer ring. In this embodiment, the PTFE-nonwoven material 17 is inserted so that it, with its inner edge, forms a sealing lip 20 that rests on the rotating surface 11 of the inner ring 3 and, with its outer edge, forms a sealing lip 30 that rests on a projection 21 of the inner ring 3. To this end, the projection 21 and the PTFE-nonwoven material 17 can be oriented relative to each other so that they form a pointed angle.

In each of the above embodiments, it is advantageous if, in addition to the dust sealing achieved with the PTFE-nonwoven material 17, there are other dust barriers, for example in the form of sealing lips 8, 9, 10 of inner ring 3, that rest on the stiffening body 14 of outer ring 5.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A cassette seal for a machine that is exposed to a large amount of external dust or dirt particles comprising at least one dust barrier, said barrier being disposed between an outer ring and an inner ring, wherein the at least one dust barrier consists of a nonwoven material impregnated with a polymer dispersion.

2. The cassette seal according to claim 1, wherein the nonwoven material is impregnated with an aqueous PTFE dispersion.

3. The cassette seal according to claim 2, wherein the nonwoven material impregnated with an aqueous PTFE dispersion is disposed at one of a surface of an outer ring or a surface of an inner ring that axially face each other.

4. The cassette seal according to claim 1, wherein the nonwoven material is firmly connected with the outer ring or the inner ring.

5. The cassette seal according to claim 1, wherein the nonwoven material is disposed in a sealing manner at a rotating surface and/or at a radial flange of the inner ring.

6. The cassette seal according to claim 5, wherein the nonwoven material is provided with a sealing lip that rests on the rotating surface of the inner ring.

7. The cassette seal according to claim 1, wherein the nonwoven material is fastened to a radial flange of the inner ring and has a sealing lip that extends outward and rests on the outer ring.

8. The cassette seal according to claim 7, wherein another nonwoven material is disposed on an axially outward oriented surface of the flange, said another nonwoven material having a radially outward extending sealing lip that rests on the outer ring.

9. The cassette seal according to claim 1, wherein the nonwoven material is inserted between the outer ring and the inner ring.

10. The cassette seal according to claim 9, wherein the inner ring is provided with an axially oriented leg that extends into an annular space formed by a stiffening body of the outer ring.

11. The cassette seal according to claim 10, wherein the nonwoven material is wedged between the leg and the outer ring.

12. The cassette seal according to claim 10, wherein the nonwoven material is wedged between a surface of the outer ring and a surface inner ring that axially face each other.

13. The cassette seal according to claim 12, wherein the nonwoven material comprises an inner edge and an outer edge, and the nonwoven material rests with its inner edge on a rotating surface and/or with its outer edge on the leg of the inner ring.

14. The cassette seal according to claim 1, wherein the inner ring is provided with at least one sealing lip that rests on a stiffening body of the outer ring and/or a housing wall of the machine.

15. A cassette seal comprising:
a housing;
an inner ring including a support ring;
an outer ring including a stiffening ring; and
a PTFE-nonwoven material disposed between the support ring and the stiffening ring.

16. The cassette seal according to claim 15, wherein the support ring includes an elastomer including a plurality of dust lips.

17. The cassette seal according to claim 15, wherein the PTFE-nonwoven material includes a sealing lip that rests on a rotating surface of the inner ring.

18. The cassette seal according to claim 15, wherein the support ring further comprises an axially oriented leg; and
another PTFE-nonwoven material is disposed between the axially oriented leg of the inner ring and the stiffening ring.

19. The cassette seal according to claim 15, wherein the support ring further comprises a radial flange; and the PTFE-nonwoven material is fastened to the radial flange.

20. The cassette seal according to claim 19, wherein the PTFE-nonwoven material includes a sealing lip that extends outward radially and rests on the outer ring.

21. The cassette seal according to claim 15, wherein the PTFE-nonwoven material includes an inner edge that forms a sealing lip that rests on a rotating surface of the inner ring; and
an outer edge that forms another sealing lip that rests on a projection of the inner ring.
